(19) United States
(12) Patent Application Publication
(10) Pub. No.: US 2021/0309951 A1
(43) Pub. Date: Oct. 7, 2021

(54) USE OF NATURAL FLAVORS AND NATURAL SMOKE FLAVORS TO ENHANCE FUNCTIONALITY OF BUFFERED ORGANIC ACIDS AND METHODS FOR PRODUCING THE SAME

(71) Applicant: Kerry Luxembourg S.à.r.I., Luxembourg (LU)

(72) Inventors: Richard S. HULL, Athens, GA (US); Bilal Kirmaci, Springfield, MO (US); Romeo Toledo, Hull, GA (US); Mo Mui Toledo, Hull, GA (US)

(73) Assignee: Kerry Luxembourg S.à.r.I., Luxembourg (LU)

(21) Appl. No.: 17/219,034

(22) Filed: Mar. 31, 2021

Related U.S. Application Data
(60) Provisional application No. 63/004,650, filed on Apr. 3, 2020.

(51) Int. Cl. C12J 1/08; A23L 27/10; A23B 4/20; A23B 4/12; A23L 13/60; A23L 13/50; A23L 13/70; A23L 13/40; A23L 3/3508; A23L 3/3472

(52) U.S. Cl. CPC C12J 1/08; A23L 27/10; A23B 4/20; A23B 4/12; A23L 13/65; A23V 2002/00; A23L 13/72; A23L 13/428; A23L 3/3508; A23L 3/3472; A23L 13/55

(57) ABSTRACT

A multifunctional natural food ingredient including a blend of natural smoke flavor rich in carbonyl compounds and buffered vinegar was developed which exhibited the ability to enhance organoleptic attributes of appearance, flavor and texture of cooked ready to eat meat products, control pathogens and aciduric psychrorophic microorganisms and extend shelf life.

### BACKGROUND

Traditionally, vinegar is a widely used culinary ingredient. Vinegar and smoke flavors have been used primarily to impart desirable flavor to foods and their synergetic capabilities point towards possible enhancement of other organoleptic and textural properties and extension of shelf-life of foods.

### SUMMARY

Various embodiments of the present disclosure are blends of natural organic acids (buffered vinegars) and natural liquid smoke flavor, here-in referred to as ISOFIN Products. The addition of these IsoFin products to foods was found to result in noticeably improved organoleptic attributes of taste, flavor, appearance, and/or texture. Considerable extension of the lag phase of growth of bacteria, yeast, and/or mold and/or reduced growth rate of these microorganisms in the treated products can also be provided, thus extending product shelf life.

In some embodiments, the IsoFin products are produced by blending a natural organic acid, such as, simple or concentrated buffered vinegar and a natural liquid smoke flavor (also referred to as natural smoke flavoring). Buffered vinegar products are industrial strength vinegar with reduced acidity obtained by treating vinegar with buffering agents such as sodium bicarbonate, sodium carbonate, potassium carbonate or potassium bicarbonate. The pH of buffered vinegar may be adjusted, for example, to either a pH range of 5.50 to 6.15 or a pH range of 4.55 to 4.85 by addition of partially neutralized and/or un-neutralized vinegar (e.g., 300 grain vinegar). A concentrated form of the buffered vinegar may be used to minimize volume on storage and transportation to facilitate efficient use at locations far from production sites. Processes for preparing buffered vinegar are described, for example, in U.S. Pat. Nos. 8,877,280 and 8,182,858, both of which are incorporated by reference herein in their entirety. The two pH ranges of buffered vinegar used to make IsoFin products are designed to optimize desired functionality of the blends when used in different types of food products. For example, IsoFin made with buffered vinegar, pH 5.85 to 6.15, when added to raw meats avoids adverse effects on water holding capacity and texture.

In some embodiments, the natural smoke flavor may be selected so as to contain a mixture of several refined pyrolysis-condensate streams to achieve a preponderance of specific carbonyl compounds. The individual pyrolysis-condensate stream may be produced via pyrolysis of specific type of plant material that would produce pyrolysis-condensate stream with the desired functional attributes. The individual pyrolysis stream may be further refined using various buffering agents and adsorbents. The plant material used to make the individual pyrolysis-condensate stream can be various types of pretreated or untreated hardwoods, softwoods, cellulose rich but lignin free feedstocks, sugar-rich (fructose, dextrose, sucrose, etc.) materials, and carbohydrate-rich materials under specifically controlled temperature (180 to 900° C.), residence time, and oxygen-deprived conditions depending on material type.

In some embodiments, the natural smoke flavor may be enriched with other plant extracts such as Neem or Tusli which exhibits natural antimicrobial activity in the untreated raw material.

In some embodiments, the disclosure provides a composition of the IsoFin product blend comprising one or more types of simple or concentrated buffered vinegar products with one or more selected natural smoke flavors having a desired concentrations of specific active carbonyl compounds. In some aspects, the natural smoke flavor is rich in the specific active carbonyl compounds. In some aspects, the natural smoke flavoring contains more than 35% by weight, more than 40% by weight, more than 45% by weight, more than 50% by weight, more than 55% by weight, more than 60% by weight, more than 65% by weight, more than 70% by weight, more than 75% by weight, more than 80% by weight, more than 85% by weight, more than 90% by weight, or more than 95% by weight of the specific active carbonyl compounds. In some aspects, the natural smoke flavoring may consist of the specific active carbonyl compounds. In some aspects, the natural smoke flavor may constitute 9 to 60% by weight of the IsoFin product, depending on its active carbonyl concentrations, with a goal of maintaining 2.0 to 10.% active carbonyl concentration, preferably 3.0 to 5.5% active carbonyl concentration, in the IsoFin product. In some aspects, the natural smoke flavor may constitute, 15 to 55% by weight, 20 to 50% by weight, 25 to 45% by weight, or 30 to 40% by weight of the IsoFin product, or any weight range between 9 to 60% by weight. The active carbonyl compounds are present in commercially available natural smoke flavors such as Red Arrow's MA45GF and MA45, Zesti Smoke's Cloud 9 (CS9) and/or Authentic Roast Flavor (ARF) in varying concentrations. In some aspects, the natural smoke flavor used in the present disclosure can be obtained from one or more of these commercially available products.

In one aspect, 40-91% of the IsoFin product blend may be a simple or concentrated buffered vinegar with pH adjusted to meet desired food product application. The pH adjustment is done based on the intended use in food product, for example, meat, poultry, turkey, vegetables, fruits, etc. The IsoFin product comprising these blends have very mild vinegar and/or smoke flavor.

In some embodiments, the disclosure provides a method of treating raw, ground, or ready-to-eat meat product to enhance texture, visual appearance, flavor, and retain water during refrigeration and cooking at the application rates of the IsoFin product of 0.5% to 5% by weight of the raw, ground, or ready-to-eat meat product. In some aspects, the application rate of the IsoFin product may be 0.5% to 2.5% meat product. In some embodiments, an IsoFin treated meat product is provided, which is the meat product treated as described herein. In some embodiments, the treated meat product can be vacuum-packaged (that is, in some embodiments, a treated meat product is provided which is the combination of a meat product and IsoFin enclosed within a vacuum-sealed package). In some embodiments, the disclosure provides a method of preparing the IsoFin product, which may include selecting the type of amount of the natural organic acid and selecting the type and amount of the natural liquid smoke flavor flavoring for the purpose of obtaining a IsoFin product that achieves one of the properties described herein (e.g., modifying the organoleptic properties, modifying the textural properties, modifying moisture retention, and/or extending shelf-life).

In some embodiments, the IsoFin treated vacuum-packaged cooked meat products exhibited no visual slime-formation for about 8 months. Additionally, the IsoFin treated meat products showed preferred textural attributes compared to those of the untreated ones due to augmented protein cross-linking by IsoFin.

In some embodiments, incorporation of IsoFin in the treated meat product extends the microbial shelf life of turkey sausage and inhibits the growth of L. monocytogenes, spoilage microflora and lactic acid bacteria in the ready-to-eat product.

Detailed features and advantages of the present disclosure are discussed below. The failure to discuss a specific feature or embodiment of the disclosure, or the inclusion of one or more features in this summary section, should not be construed to limit the claims.

### BRIEF DESCRIPTION OF THE DRAWINGS

The patent or application file contains at least one drawing executed in color. Copies of this patent or application publication with color drawing(s) will be provided by the Office upon request and payment of the necessary fee. The foregoing summary, as well as the following detailed description of certain embodiments of the application, will be better understood when read in conjunction with the appended drawings. In the drawings:

FIG. 1 shows appearance of samples after cooking up to 170° F. in a convection oven;

FIG. 2 shows force required to shear the cooked samples;

FIG. 3 shows deflection (stretchiness) to total shear for the cooked samples;

FIG. 4 shows firmness of the skin of the cooked samples;

FIG. 5 shows total Active Carbonyl Compounds and differences in their concentrations in the IsoFin products and CS9;

FIG. 6 shows available lysine residues (Available Lysine, %) remaining on bovine serum albumin (BSA, 10 mg/mL) after incubation with selected active carbonyls (each at 30 mM working concentration) at 70° C.;

FIG. 7 shows IsoFin treated turkey bacon stored in refrigerator since Mar. 25, 2019 showing no signs of white slime layer after 8 months of storage in a refrigerator;

FIG. 8 shows protein crosslinking ability, as measured by decrease in lysine residue availability, of IsoFin B, CS9, and MA45GF samples; and,

FIG. 9 shows chicken breast dipped for 5 minutes in IsoFin B (MA45GF based) and IsoFin B (CS9 based) at 25% dilution, followed by cooking at 170° F. in a countertop convection oven.

### DETAILED DESCRIPTION

Meat processors of ready-to-eat meat and poultry products use a variety of antimicrobials and other functional ingredients to enhance specific organoleptic properties and/or increase shelf life and/or prevent the potential growth of specific foodborne pathogens. Increased shelf life not only allows processors to display products on a retail store shelf for extended durations for customers, but also to provide flexibility in scheduling of processing operations during production and distribution.

The microorganisms of specific importance regarding shelf life of ready-to-eat meat and poultry products that are vacuum packaged and marketed under refrigeration include total microbial populations, psychrotrophic populations, lactic acid bacteria and the foodborne pathogen Listeria monocytogenes. In most of the ready-to-eat meat and poultry products, antimicrobials based on organic acid salts or their variants are widely used to inhibit L. monocytogenes growth. However, inclusion of these antimicrobials favors the growth of psychrotrophic lactic acid bacteria, which can tolerate moderate pH values that are inhibitory to most other spoilage microorganisms.

The IsoFin product of the present disclosure extends the microbial shelf life of meat, ready-to-eat meat and poultry products. It inhibits the growth of lactic acid bacteria and L. monocytogenes as well as the spoilage microflora in ready-to-eat meat products.

In addition, the IsoFin product of the present disclosure can also solve another problem faced by the food industry, which is related to the texture of the meat products prepared from ground meat. After raw meat is ground, mixed with other ingredients, formed into the desired shape and cooked, such as, for example, turkey bacon, hot dogs, sausages, etc., the finished product loses the desirable textural attributes of stretchiness, firmness, and elasticity that are characteristics of products from whole muscle. The present disclosure provides a novel solution to the problem of achieving products prepared from ground meat with textures like those of products from whole muscle. IsoFin products as an ingredient promote cross-linking between meat protein molecules to result in a texture of formed ground meat products like that of whole muscle meat. In addition, IsoFin addition does not impart any off-flavors or discoloration to the final meat product.

Buffered vinegar-based products have been used in the food industry as proven shelf life extender and inhibitors of pathogens (including spores). Vinegars have strong overpowering flavor notes, therefore their use in flavor formulations for meat applications require extensive dilution to partially neutralize acidity and reduce sensory sourness. However, at the diluted concentrations, buffered vinegars are not very effective against yeast and mold and have limited effectiveness on inhibition of gram-negative bacteria.

Smoke flavors applied in gaseous form, in smoke houses, to meat products have antimicrobial attributes, which are enhanced by the reduction of water activity as dehydration occurs during smoke exposure. However, when smoke flavor is applied as a natural liquid smoke flavor, antimicrobial effectiveness is reduced due to excessive dilution needed to avoid negative sensory attributes.

The Isofin products in the present disclosure harness the synergistic effects of natural organic acid, such as, buffered vinegars and plant derived natural smoke flavors (active carbonyl compounds) for enhanced sensory and food preservative attributes, thereby, developing a natural multifunctional ingredient.

Natural multifunctional ingredients, like IsoFin products, are highly desired by the food industry to allow the use of a clean label which lists a minimum of ingredients of only familiar consumer-friendly natural ingredients and no synthetic chemical sounding names on the product label. For example, turkey bacon is produced from ground turkey meat and ingredients (cross linker and flavor enhancers) are added for its textural and taste enhancement to mimic real bacon. Other ingredients (organic acid salts) are added to extend shelf life.

In literature, GB 855 350 A (Uniliver Ltd), 30 Nov. 1960 and PCT/EP2018/060973 (Kerry Luxembourg), 27 Apr. 2018 reacted commercial liquid smoke with amino acids to convert part of carbonyls present in it to produce substances with unique flavors and properties. These reacted smoke products had a high solids concentration, which when applied to meat products created a thick surface layer (skin), a little thicker than when liquid smoke alone was applied. This patent groups all chemical compounds present in the liquid smoke into a single term “carbonyl” measured as the equivalent of 2-butanone standard. Every liquid smoke contains a cocktail of chemical compounds generated during pyrolysis. Several of these chemical compounds, not all, participate actively as cross-linker or flavor enhancer or antimicrobial agents, here referred as Active Carbonyl Compounds. Knowing the concentration and activity/functionality of each individual active carbonyl compound will be necessary to develop a consistent smoke flavor product for a given application.

CN 106376897A (Anhui Tianmei Food Co Ltd) 6 Feb. 2018 used a mixture of rose essential oil, liquid wood smoke, and red wine to pretreat beef before cooking to make it more brittle post cooking followed by oven-drying. A limitation of this reference is the failure to identify the compounds present in the liquid smoke that were responsible for beef's brittleness, and therefore, it is not possible to generate liquid wood smoke with the same chemical make-up.

Different chemical compounds present in liquid smoke, grouped together as carbonyls, display different reactivity to different amino acids, according to a report by Riha and Wendorff (1993, Journal of Food Science, vol 58-3, pages 671-674). According to the report, glycolaldehyde, methylglyoxal, and glyoxal are most reactive with amino acids to produce the brown color. In other words, these compounds are capable of reacting with and cross-linking protein molecules in the ready to eat food product.

Likewise, reactivity of various liquid smoke fractions against pathogens and food spoilage organism has been reported by Milly et al. (2005, Journal of Food Science, vol 70-1, page M12-17). In their report, nine different liquid smoke fractions containing different amounts of carbonyls and pH values were tested for minimum inhibitory concentrations (MIC). According to the report, the liquid smoke fraction having the highest carbonyl concentration and the lowest pH was most effective against all microorganisms (Lactobacillus plantarum, Listeria innocua M1, Salmonella, Escherichia coli, Saccharomyces cerevisiae, and Aspergillus niger).

The present disclosure teaches the development of a composition containing of natural organic acids (buffered vinegars) and natural smoke flavors (Active Carbonyl Compounds or Other Active Natural Compounds), herein referred to as IsoFin products. In some aspects, the IsoFin product may consist essentially of the natural organic acids (buffered vinegars) and the natural smoke flavors (Active Carbonyl Compounds or Other Active Natural Compounds), or may consist of the natural organic acids (buffered vinegars) and the natural smoke flavors (Active Carbonyl Compounds or Other Active Natural Compounds).

The IsoFin products have demonstrated improved textural characteristics (e.g., stretchiness, firmness, and/or resistance to shear) of cooked meat products due to its excellent cross-linking ability with proteins while not creating any off flavors (see Example 1 below).

The IsoFin products have also demonstrated extended microbial shelf life of ready-to-eat turkey sausage through inhibition of the growth of L. monocytogenes as well as the spoilage microflora, lactic acid bacteria (see Example 2 below).

The present disclosure teaches about dominant carbonyl compounds present in natural smoke flavor and their protein crosslinking abilities (see Example 4 and 5 below).

The IsoFin products have also demonstrated inhibition of slime-forming bacteria in vacuum-packaged cooked meat. The IsoFin products have also successfully suppressed slime formation for more than 8 months in a vacuum packaged meat (see Example 6 below).

The IsoFin products made using two different natural smoke flavor (CS9 and MA45GF) have demonstrated effectiveness for protein crosslinking (see Example 7 below).

The IsoFin products made using two different natural smoke flavor (CS9 and MA45GF) have demonstrated positive impact on texture, taste, and flavor of cooked chicken (see Example 9 below).

These compositions can be used not only to enhance the organoleptic attributes of ready to eat ground meat similar to that of whole muscle meat, but they can also be labelled as “vinegar and natural flavors,” thereby replacing a long list of ingredients on the product label. Furthermore, consumer testing indicated a preference for the texture (chewiness and fibrousness) of the IsoFin products treated ground meat products.

The IsoFin products can be all natural, i.e., the composition may contain only ingredients which are classified as natural (e.g., natural organic acid, vinegar, natural smoke flavor, and natural plant extracts). In some embodiments, the IsoFin product may consist of only the natural organic acid, vinegar, natural smoke flavor, and/or natural plant extracts.

The term “natural plant extract” refers to any extract derived from plant material using non-chemical methods including, but not limited to, leaves, stems, wood, flowers, fruits, seeds, roots, nectar, and combinations, thereof.

The IsoFin products may be created by blending buffered vinegar or other natural. organic acids (propionic acid, lactic acid, etc.) with one or more active natural ingredients to enhance its multiple functionality.

### EXAMPLES

### Example 1

To compare the cross-linking ability of the IsoFin products (IsoFin B) with that of buffered vinegar and related liquid smoke flavor (CS9), tests were conducted on chicken breast meat. Some key characteristics of the CS9, IsoFin Product B, and buffered vinegar are presented in Table 1. The buffered vinegar (Homestyle Vinegar Flavor, Lot #19108SP2, IsoAge Technologies, Athens, Ga.) was commercially made according to the process described in the section [0003]. The CS9 product was procured from Kerry-Zesti Smoke (Cloud S 9, lot #0710938702, Kerry America Region, Monterey, Tenn.). The IsoFin Product B (lot #19098 RD3, IsoAge Technologies, Athens, Ga.) was made by mixing buffered vinegar and CS9 in the ratio of 1:1 by weight and it was used in other examples unless specified differently. The total concentration of active carbonyls in the CS9 and IsoFin Product B was 2016 mg/100 mL and 1297 mg/100 mL, respectively as measured by derivatization (PFBHA)-GC-MS analysis. The buffered vinegar, liquid smoke flavor (CS9), and IsoFin product were diluted with water at about 25% dilution. About 5 lbs. of boneless chicken breast meat was purchased from a local grocery store. The chicken meat was divided into 16 samples. Each sample was weighed. Four samples were kept as control, while remaining 12 samples were evenly assigned to the three dilutions for treatments. The samples were dipped into a diluted solution, one at a time, for about a minute. After that, the dipped sample was placed on a screen to let excess solution drip out from the sample. Following that, each sample was weighed again. At the conclusion of dipping treatments, there were 4 control samples, 4 buffered vinegar treated samples, 4 CS9 treated samples, and 4 IsoFin treated samples. The samples were stored in refrigerator for about 45 hours prior to cooking. The samples were cooked to about 170° F. in a convection oven. After cooking, the samples were allowed to cool-down and then stored in Ziplock bags in a refrigerator. The Warner-Bratzler meat shear test was used to determine the extent of protein cross-linking induced in each of the three treatments as manifested by higher Warner-Bratzler shear values with increased protein cross-linking. About 17 hours after cooking, the Warner-Bratzler meat shear tests were conducted on the refrigerated samples following the standard protocol and data on force required to shear, total deflection from time of contact of the blade with the sample to total shear and energy required to shear the sample were collected. The collected data was analyzed to compare cross-linking ability of the control, buffered vinegar, liquid smoke flavor (CS9), and IsoFin product treatments. Additionally, skin puncture tests were conducted to measure firmness of the surface skin of the cooked samples. Skin was formed due to a combination of cross-linking and dehydration by cooking. A standard plunger (2 mm diameter) was made to penetrate the sample up to 5 mm depth and force required to puncture the sample was recorded.

TABLE 1
Key characteristics of CS9, IsoFin product, and related buffered vinegar.

| | | | Acetate, | | | Non-Volatile |
|---|---|---|---|---|---|---|
| | | | % as | Acetate (s), | Acetate | Solids |
| Product | pH | TA, % | acid | % as salt | (s)/Acid | (%) |
| CS9 | 5.05-5.25 | 1.11-1.68 | 4.2-4.8 | 3.09-3.12 | 1.86-2.78 | 10.13 ± 0.25 |
| IsoFin B | 5.60 | 1.38-1.54 | 13.2-13.7 | 11.7-12.3 | 7.60-8.91 | 20.8 ± 0.4 |
| Buffered Vinegar | 5.8-6.2 | 1.1-1.3 | 21.6-24.0 | 20.5-22.5 | 14.0-17.0 | 31.2 ± 0.4 |

### Results for Example 1

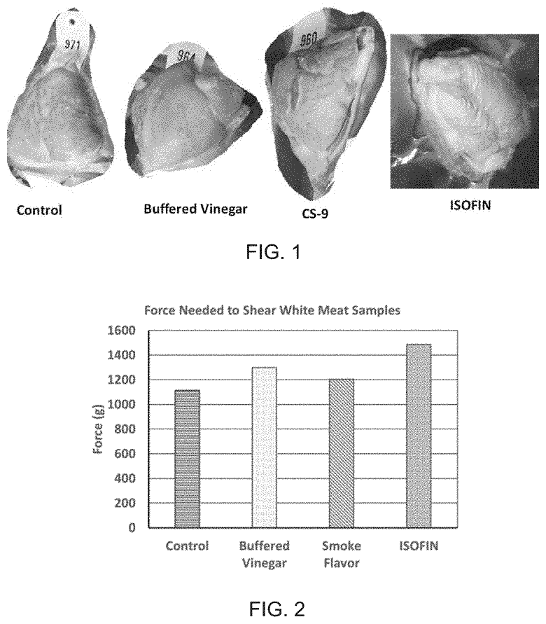

Mass balance data from pre- and post-dipping showed that the 1.9% (g per 100 g of meat) buffered vinegar (25% dilution) adhered to the meat compared to 2.6% and 2.8% for the CS9 and IsoFin product (25% dilution), respectively. FIG. 1 shows the appearance of the control and treated samples after cooking. Visually, the CS9 treated and IsoFin treated samples had more browning due to Maillard reactions compared to the control and the buffered vinegar treated samples. Moreover, the IsoFin product treated sample had appearance of thicker skin formation than any other sample.

The average force required to shear the samples is shown in FIG. 2. Each data point is an average of 8 measurements (4 samples and 2 measurements per sample). The FIG. 2 shows that the IsoFin product treated samples took 1486.11 g force to shear, which was 33% higher than that for the control sample and 15% and 24% higher than that for the buffered vinegar and smoke flavor (CS9) treated samples. Therefore, the IsoFin product provides better cross-linking than the individual constituents it is made from (buffered vinegar and CS9).

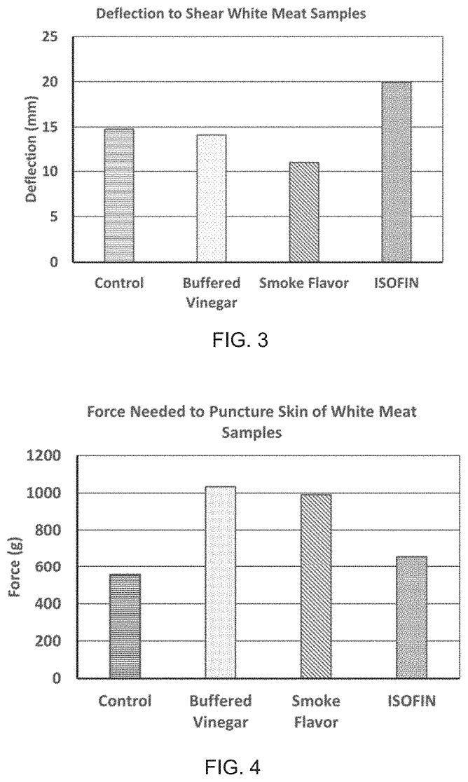

Another textural property of the meat samples in Example 1 is the extent of stretching of meat samples prior to total shear failure, measured as deflection. Deflection was measured as the distance traveled by the shear head from time it contacts the specimen surface to the point of total shear failure of the specimen. FIG. 3 shows deflection of the samples prior to total shear failure. The IsoFin B treated samples stretched the most, up to 20 mm before it failed, which was 35% higher than control. The deflection of the smoke flavor treated samples was lower than that for control and other samples, which agrees with the patent report from B. CN 106376897A (Anhui Tianmei Food Co Ltd) 6 Feb. 2018. According to the report, the smoke flavor was used to generate brittleness to the beef samples. The IsoFin B product changes texture of the meat samples to become more stretchy and therefore, when IsoFin B is used as an ingredient in ground meat, it makes the cooked meat to be very similar to cooked whole muscle meat tissue.

Skin puncture tests were performed to evaluate the samples for the firmness of the skin formed (in g force) due to combination of cross-linking and cooking and results are presented in the FIG. 4. All three treatments generated higher skin firmness than the control. Individually, the buffered vinegar and smoke flavor (C S9) generated meat with skin firmness of about 1000 g force. However, the IsoFin B treated meat samples had average skin firmness of about 656 g force, which in turn is a good outcome because the IsoFin create product, which is not very firm to bite into, but it gives more chewiness/stretchiness to the texture of the product as demonstrated by deflection results.

### Example 2

In a study, the IsoFin product was evaluated for its efficacy in extending shelf life and control L. monocytogenes growth in a generic turkey sausage.

Generic turkey sausage samples were prepared without (control) and with the application of the IsoFin product. For each of the three replicates, 2 kg of turkey thigh meat were procured from a meat processor and shipped overnight under refrigeration. The meat was ground through a 12.7 mm plate and mixed for 1 min while adding the ingredients (Table 2). For treatments requiring IsoFin product, the ingredient was added to the water and then added to the meat during mixing. The control treatment was mixed similarly but without the Isofin. The treated and control ground meat was stuffed into 5.08 cm dia. fibrous mahogany casings (Visko Teepak, Kenosha, Wis.), and hand-tied. The chubs were then hung on a smoke cart, and placed in an Alkar smokehouse (Model 8770-4-12000, Lodi, Wis.). A typical sausage cooking schedule was followed, with the final target internal temperature of 73.9° C. The product was showered with cold water and transferred to a cooler for 24 h. The chubs were peeled and sliced (0.32 cm) using a Hobart slicer. About half of the samples were used for shelf life determination and the other half was used for inoculation with cocktails of L. monocytogenes and lactobacilli. Five strains of L. monocytogenes (F8369 [1/2a], G6006 [1/2b], Scott A [4b], G3990 [4b], BilMar [non-typed]) and lactic acid bacteria (LAB; Lactobacillus plantarum, Lactobacillus casei, L. sakei, Leuc. mesenteroides, and Leuc. citrovorum) were used in this study.

For inoculation of the prepared sausage with microorganism, a loopful of the individual cultures was transferred to sterile brain heart infusion broth (BHI; 10 mL) and incubated for 18 h at 35° C. The individual cultures were mixed to obtain a cocktail and serially diluted in peptone water (0.1%, PW). A 50 μL aliquot of the cocktail was drop inoculated on to a slice of the sausage, another slice of the sausage was placed on the inoculated side and the product was placed inside a vacuum packaging bag and sealed. The bag was from Prime Source, Kansas City Mo. The bags were 3 mil standard barrier nylon vacuum pouch with a water vapor transmission rate of 10 g/L/m2/24 h at 37.8° C. and 100% relative humidity and an oxygen transmission rate of 3000 cm3/L/m2/24 h at 23° C. and 1 atm. Product samples were inoculated with LAB cultures and separate samples were inoculated with L. monocytogenes and packaged separately. The inoculated product, along with a non-inoculated product (for shelf life evaluation) was stored under refrigeration (1.7° C.) for various periods of time and microbial populations were determined.

After a designated storage period, enumeration of microorganisms was performed. The external surface of the vacuum bags containing the meat were sanitized using ethanol (70%) and allowed to dry. The bags were opened with sanitized scissors and the meat was transferred to a sterile filter stomacher bag containing 50 mL of PW. The sample was stomached for 1 min and serially diluted in PW. Appropriate dilutions were plated on Petrifilm APC, EC/TCC, YM, and LAB plates. The plates were incubated for specific periods at appropriate temperatures as specified by the manufacturer. For enumeration of the L. monocytogenes, the samples were spread plated on modified oxford agar (MOX) plates and incubated for 24 h at 35° C. and typical colonies were enumerated and expressed as log CFU/cm².

Additionally, water activity and pH measurements for the samples were performed. The water activity (a_{w}) of the meat products was measured using an Aqua Lab 3TE water activity meter (Decagon Devices Inc., Pullman, Wash.) following the protocol described by the manufacturer. For pH measurement, a 5 g portion of meat sample was transferred to a filter stomacher bag, 20 mL of deionized distilled water was added, and the sample was homogenized for 2 min in a stomacher. The pH of the homogenate was determined by immersing the combination electrode of pH meter (Model Accumet Basic/AB15, Fisher Scientific, Pittsburgh, Pa.). The pH meter was calibrated using pH 4.0, 7.0, and 10.0 standards before analysis of samples.

### Results for Example 2

The pH and water activity of the products were 6.45±0.11 and 0.98±0.01, respectively. Incorporation of IsoFin product into the turkey sausage at 1.5 and 2.5% of the formulation did not affect the pH and water activity of the product.

Initial APC (aerobic plate count) and YM (yeast mold) populations of the turkey sausages were 1.69 and 0.26 log CFU/cm², respectively. Total coliform populations were below the detection limit (0.15 log CFU/cm²) of the enumeration method. Inoculation of the turkey sausages with LAB and L. monocytogenes resulted in 1.52 and <0.15 log CFU/cm², respectively. Storage of turkey sausages at 1.7° C. resulted in APC population of 2.74, 5.48, 5.59, 6.03, and 6.03 log CFU/cm² subsequent to 14, 28, 42, 56 and 70 days, respectively (Table 3). Incorporation of IsoFin product in the turkey sausage formulation resulted in inhibition of APC population, with final population of 5.79 and 2.69 log CFU/cm² at incorporation rate of 1.5 and 2.5%, respectively. The TCC (total coliform) population was minimal, with inconsistent, but low populations <0.36 log CFU/cm² throughout the storage period of 70 days. The final YM population was 3.07, 3.68 and 4.00 log CFU/cm² on the control turkey sausage, and those containing 1.5 and 2.5% IsoFin product, respectively.

Incorporation of IsoFin product into turkey sausage formulation resulted in inhibition of LAB population up to day 56, with populations of 6.24, 4.83 and 4.18 log CFU/cm², in control turkey sausage and turkey sausage containing 1.5 and 2.5% of IsoFin product.

L. monocytogenes (Lₘ) populations of 3.79, 6.39, 6.23, 7.68 and 8.22 log CFU/cm² were observed subsequent to storage at 1.7° C. for 14, 28, 42, 56 and 70 days, respectively. Inhibition of L. monocytogenes growth was observed in turkey sausages containing 1.5 and 2.5% IsoFin product, with higher concentration resulting in greater inhibition of growth.

While current food industry uses organic acid salts and their combinations to control L. monocytogenes in ready-to-eat meat and poultry products, they are not as effective in controlling the growth of spoilage microorganisms in vacuum packaged, extended shelf life products. The example 2 demonstrates that incorporation of IsoFin product extended the microbial shelf life of turkey sausage and inhibited the growth of L. monocytogenes as well as the spoilage microflora, lactic acid bacteria in ready-to-eat turkey sausage.

TABLE 2
Turkey sausage formulation (g/Kg of product) containing IsoFin product.

| Ingredient wt. (g) | Control | IsoFin (1.5%) | IsoFin (2.5%) |
|---|---|---|---|
| Turkey thighs/15% trim | 0.866 | 0.866 | 0.866 |
| Water | 0.003 | 0.003 | 0.003 |
| Veg Stable 525 | 0.007 | 0.007 | 0.007 |
| Sea salt | 0.091 | 0.076 | 0.066 |
| Veg Stable 5065 | 0.004 | 0.004 | 0.004 |
| Cal. Ham Spice | 0.000 | 0.000 | 0.000 |
| Sod Phosphate | 0.003 | 0.003 | 0.003 |
| Raw Sugar | 0.020 | 0.020 | 0.020 |
| Merisal 57 Salt | 0.007 | 0.007 | 0.007 |
| ISOFIN Product | | 0.015 | 0.025 |
| Product weight (Kg) | 1.00 | 1.00 | 1.00 |

TABLE 3
Microbiological profile of turkey sausage samples (Control, treated with 1.50% ISOFIN, and
treated with 2.50% IsoFin products) during refrigerated storage at 1.7° C.

| Day | Treatment | APC | TCC | YM | LAB | Lm |
|---|---|---|---|---|---|---|
| 0 | Control | 1.68 ± 0.05 | 0.15 | 0.28 ± 0.23 | 1.47 ± 0.14 | 0.15 |
| | 1.50% | 1.65 ± 0.52 | 0.15 | 0.28 ± 0.23 | 1.51 ± 0.23 | 0.15 |
| | 2.50% | 1.64 ± 0.38 | 0.15 | 0.23 ± 0.14 | 1.34 ± 0.38 | 0.15 |
| 14 | Control | 2.74 ± 0.27 | 0.23 ± 0.14 | 0.75 ± 0.61 | 1.71 ± 1.25 | 3.79 ± 0.74 |
| | 1.50% | 2.76 ± 0.26 | 0.15 ± 0.00 | 0.54 ± 0.47 | 1.36 ± 0.50 | 1.44 ± 1.15 |
| | 2.50% | 2.72 ± 0.23 | 0.37 ± 0.38 | 0.15 ± 0.00 | 0.91 ± 0.76 | 0.75 ± 0.63 |
| 28 | Control | 5.48 ± 1.75 | 0.36 ± 0.36 | 1.33 ± 1.16 | 4.01 ± 1.21 | 6.39 ± 2.09 |
| | 1.50% | 2.17 ± 1.38 | 0.20 ± 0.09 | 0.64 ± 0.46 | 2.87 ± 0.39 | 3.24 ± 2.10 |
| | 2.50% | 1.87 ± 1.54 | 0.10 ± 0.09 | 0.16 ± 0.02 | 2.57 ± 0.51 | 1.91 ± 1.60 |
| 42 | Control | 5.59 ± 0.60 | 0.15 | 4.07 ± 1.05 | 5.70 ± 0.17 | 6.23 ± 0.97 |
| | 1.50% | 2.81 ± 1.88 | 0.15 | 3.73 ± 0.85 | 5.57 ± 0.39 | 4.23 ± 0.24 |
| | 2.50% | 3.13 ± 1.91 | 0.15 | 3.87 ± 1.24 | 3.81 ± 3.17 | 2.34 ± 0.84 |
| 56 | Control | 6.03 ± 0.21 | 0.15 | 3.07 ± 0.04 | 6.24 ± 1.10 | 7.68 ± 0.59 |
| | 1.50% | 5.79 ± 1.00 | 0.15 | 3.68 ± 0.80 | 4.83 ± 1.15 | 5.22 ± 1.64 |
| | 2.50% | 2.69 ± 2.23 | 0.15 | 4.00 ± 0.54 | 4.18 ± 2.16 | 3.06 ± 0.39 |
| 70 | Control | 6.03 ± 0.21 | 0.15 | 3.07 ± 0.04 | 6.01 ± 0.24 | 8.22 |
| | 1.50% | 5.79 ± 1.00 | 0.15 | 3.68 ± 0.80 | 6.02 ± 2.11 | 7.21 |
| | 2.50% | 2.69 ± 2.23 | 0.15 | 4.00 ± 0.54 | 7.52 ± 0.00 | 3.00 |

Note:
APC = Aerobic Plate Count,
TCC = Total Coliform,
YM = Yeast Mold,
LAB = Lactic Acid Bacteria, and
Lₘ = L. monocytogenes populations

### Example 3

Two IsoFin Products (product A and product B) were made using two types of buffered vinegars and one type of natural liquid smoke flavor (CS9) and were compared for total carbonyls, staining index, browning index, pH, and Titratable Acidity (TA). The IsoFin product A (lot #19254 UGA1, IsoAge Technologies, Athens, Ga.) was made using different buffered vinegar (Farmstyle Vinegar Flavor, lot #19172SP2, IsoAge Technologies, Athens, Ga.). The buffered vinegar, Farmstyle Vinegar Flavor, has typical pH of 4.7±0.2, titratable acidity in the range of 10.2 to 12.0, total acetate content of 22.0 to 23.0%, acetate (salt) content of 11.0 to 12.8%, moisture content of 68.7 to 71.1%, and non-volatile solid content of 19.0±0.3%. The carbonyls were measured using standard butanone method, which is widely used in the smoke industry, therefore, they are referred as butanone-based carbonyls.

### Results for Example 3

Results of the analysis are presented in Table 4. The results showed that the IsoFin products had half the butanone-based total carbonyls and much less staining and browning index compared to the natural liquid smoke flavor. In addition, the IsoFin product B has a pH and TA like the CS9.

TABLE 4
Properties of IsoFin Products and natural flavoring used to make them.

| | Total Carbonyls | Staining | Browning | | |
|---|---|---|---|---|---|
| | (TC) | Index | Index | | TA |
| Sample | (g/100 ml) | (SI) | (BI) | pH | (%) |
| C59 | 7.0 | 70.4 | 9.06 | 5.07 | 1.40 |
| IsoFin Product A | 3.6 | 36.7 | 1.97 | 4.70 | 8.50 |
| IsoFin Product B | 2.8 | 46.1 | 1.81 | 5.60 | 1.43 |

### Example 4

Two IsoFin products (A and B) and CS9 were also tested for individual active carbonyls using a standard method (derivatization (PFBHA)-GC-MS analysis) and their sum is referred as Total Active Carbonyl Compounds. This method captures concentration of individual carbonyl compounds that are present in high concentration.

### Results for Example 4

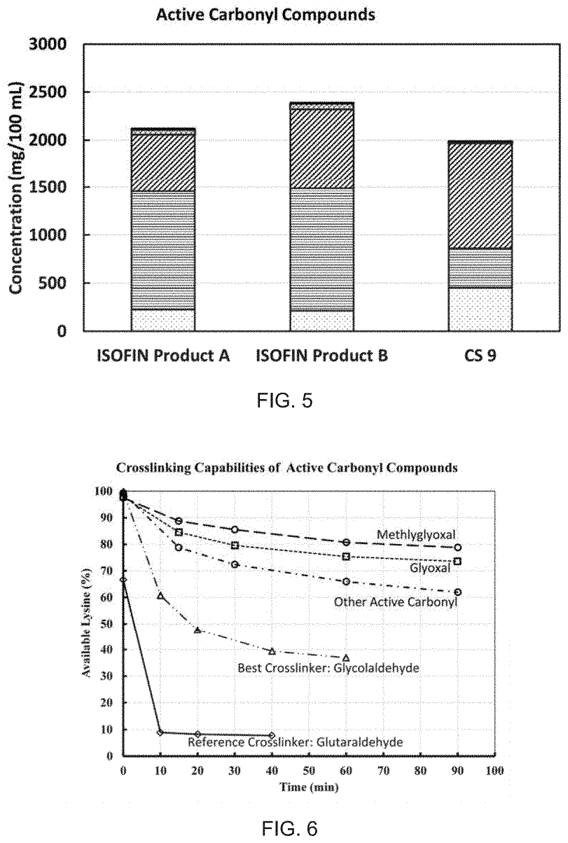

The IsoFin products as well as CS9 contain the total Active Carbonyl Compounds that ranged from 2.2 to 2.4 g/100 mL, with IsoFin product B having higher amounts of total Active Carbonyl Compounds than the CS9 (FIG. 5). The active carbonyl compounds represent about 94-97% of the total carbonyls present. The concentrations of individual active carbonyl compounds differ between CS9 and IsoFin Products (FIG. 5). The dominant Active Carbonyl Compounds present in the IsoFin Products are glycolaldehyde, glyoxal, and methylglyoxal. Moreover, the IsoFin products were stored in the laboratory at 70-77° F. temperature for a period of 3 months and tested for changes in the total Active Carbonyl Compounds, staining index and browning index. Results showed that there was some reduction in the total Active Carbonyl Compounds content during storage period of three months (from 2.4 mg/100 mL to 1.5 mg/100 ml. However, the staining index reduced from 46.8 to 13.8 in one-month storage period. Likewise, the browning index reduced to 0.84 from its initial value of 1.81 during the same storage period.

### Example 5

Selected active carbonyl compounds (glycolaldehyde, glyoxal, methyl glyoxal, and other carbonyls) were compared for their protein crosslinking capability. Standard reference materials were purchased from Sigma Aldrich [Glycolaldehyde (material no. G6805-5G, batch no. STBG0623V), Glyoxal (material no. 128465-500G, batch no. STBH8032), Methylglyoxal (material no. M0252-250 ml, batch no. BCBT1161), and other carbonyl (material no. F8775-500 ml, batch no. MKCK0272)]. Glutaraldehyde used as a reference material. The protein crosslinking capability was measured as their reactivity with lysine residues on bovine serum albumin (FIG. 6). In the Protein Crosslinking method, experiments were conducted at 30 mM working concentration of individual carbonyls and at 70° C.

### Results for Example 5

Among various standard reference materials tested, glycolaldehyde showed maximum reactivity with lysine (FIG. 6). Therefore, concentration of glycolaldehyde was benchmarked in further IsoFin product formulations as well as in source pyrolysis-derived smoke flavor streams (CS9 or MA45GF).

### Example 6

The IsoFin products are recommended to use at level of 0.5% to 2.5% by weight of the meat product. The IsoFin B was used to treat turkey bacon. The turkey bacon was then vacuum-packaged on Mar. 25, 2019 and stored in refrigerator.

### Results for Example 6

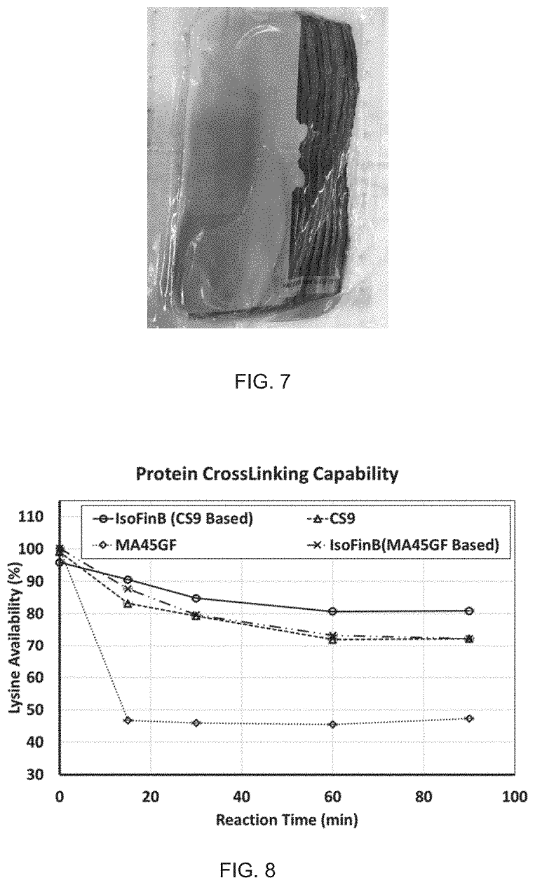

Generally, all ready-to-eat meat products available in commercial markets develop a white slime in a matter of 28-30 days. However, IsoFin treated turkey bacon shows no signs of white slime after 8 months of storage (FIG. 7).

### Example 7

Two IsoFin Products were made using two different types of natural liquid smoke flavors (CS9 and MA45GF) and were compared for total carbonyls and protein crosslinking capability. Among the two, the IsoFin B (CS9 based) was made with 50% CS9 (lot #0218938702, Zesti Smoke, Kerry America Region, Monterey, Tenn.) and 50% Homestyle vinegar flavor (IsoAge Technologies, Springfield, Mo.), whereas the IsoFin B (MA45GF based) was made with 9% MA45GF (lot #0214042186, Red Arrow, Kerry America Region, Manitowoc, Wis.)), 1% 300 grain vinegar (lot #09918209), and 90% Homestyle vinegar flavor. The formulations of the two ISOFIN Products had different amounts of smoke flavoring to ensure that the minimum concentrations of total active carbonyls (glycolaldehyde and glyoxal) at 2% or above. Additionally, different Individual carbonyls were estimated by derivatization (PFBHA)-GC-MS analysis (Table 5). Additionally, protein crosslinking capability of the IsoFin products, CS9, and MA45GF were tested by measuring their reactivity with lysine residues on bovine serum albumin (FIG. 8). In the Protein Crosslinking method, experiments were conducted at 2.5% v/v working concentration samples and at 70° C. (158° F.).

### Results for Example 7

Protein crosslinking results show that the MA45GF is the most reactive with lysine, leaving only 47.3% of unreacted lysine (FIG. 8), which is due to it's the highest active carbonyl concentration (Table 5). The CS9 and IsoFin B (MA45GF based) sample have 2.3 to 2.8% active carbonyls and about 72% unreacted lysine during crosslinking tests. Therefore, the ISOFIN products must have more than 2.5% active carbonyls with abundance of glycolaldehyde.

TABLE 5
Active carbonyl contents of IsoFin Products and
natural flavoring used to make them.

| | IsoFin B | | | IsoFin B |
|---|---|---|---|---|
| Sample | (C59 Based) | C59 | MA45GF | (MA45GF Based) |
| Other Carbonyls, | 180 | 410 | 4413 | 308 |
| mg/100 ml | | | | |
| Glycolaldehyde*, | 1899 | 2259 | 29354 | 2351 |
| mg/100 ml | | | | |
| Glyoxal*, mg/100 | 61.2 | 57.8 | 2456 | 202 |
| ml | | | | |
| Methyl Glyoxal*, | 0 | 0 | 4175 | 245 |
| mg/100 ml | | | | |
| Active | 1960 | 2317 | 35985 | 2798 |
| Carbonyls* | (1.9%) | (2.3%) | (35.9%) | (2.8%) |

### Example 8

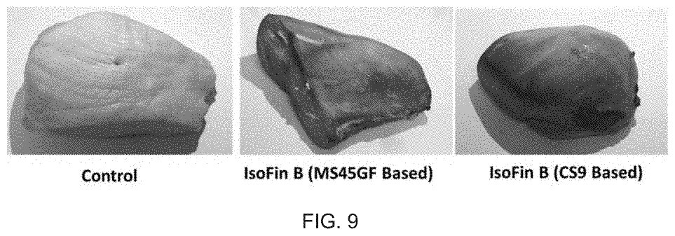

To understand taste and texture implications of IsoFin B (MA45GF based) and IsoFin B (CS9 based) on meat-based food, chicken breasts were treated with them and cooked to 170° F. end point temperature. The treatments were done by dipping chicken breasts in a 25% solution of IsoFin B (MA45GF based) and IsoFin B (CS9 based). FIG. 8 shows visual appearance of the untreated and treated cooked chicken breasts. No obvious color differences were noticed between the two treatments (FIG. 9). The cooked samples were tasted by a panel of two employees for tenderness, skin formation, and taste differences.

### Results for Example 8

Among two treatments and control tasted by the employees, they favored the chicken breasts treated with IsoFin B (MA45GF based) due to its tenderness and appealing flavor containing mild smoky notes. A summary of comments from the taste panel is presented in Table 6.

TABLE 6
Summary of tenderness and taste testing of chicken breasts treated
with IsoFin B (MA45GF based) and IsoFin B (CS9 based).

| Product used | Comments |
|---|---|
| Control- No Product | Tender with no skin |
| IsoFin B (CS9 Based) | Less tender than control with no skin |
| | Different taste compared to control |
| | Slight vinegary notes |
| IsoFin B (MA45GF | Felt more tender than control with no skin |
| Based) | Better flavor than control with very mild |
| | smoky notes |
| | Taste almost like control |

### Example 9

Three IsoFin Products, namely, IsoFin A, IsoFin B, and IsoFin M were evaluated. The difference between these products is that the IsoFin A was made with the Farmstyle vinegar flavor (simple buffered vinegar) and MA45GF, whereas the IsoFin B was made with the Homestyle vinegar flavor (simple buffered vinegar) and MA45GF. The IsoFin M differs with IsoFin A and B because it was made with MoStatin VLS (concentrated buffered vinegar) and MA45GF. Samples of IsoFin A, IsoFin B, and IsoFin M were prepared and tested for active carbonyl concentration, pH, titratable acidity, total acetate, acetate salts, and specific gravity. The IsoFin A sample was prepared with 90% Homestyle vinegar (lot #20220SP3) and 10% MA45GF (lot #0429042477). The IsoFin B sample was made with 89% Homestyle vinegar flavor (lot #20239SP1), 1% 300 grain vinegar (lot #09918209), and 10% MA45GF (lot #0429042477). The IsoFin M sample was made with 90% MoStatin VLS (lot #20104SP1) and 10% MA45GF (lot #0429042477). Table 7 presents side by side analytical comparison of the IsoFin A, IsoFin B, IsoFin M, and MA45GF. From the table several key comparison points may be drawn.

### Results for Example 9

IsoFin A, IsoFin B, and IsoFin M were very similar in total carbonyls which range from 4.4% to 6.1% and active carbonyls, primarily glycolaldehyde concentration were about 3.3% to 4.4%. IsoFin A had a pH of about 4.73, whereas the pH was about 5.54 to 5.77 for the other samples. IsoFin A had titratable acidity of about 10.71, whereas the titratable acidity was 3.59% for IsoFin M and 1.85% for IsoFin B. In addition, there was about 17.38% sodium and potassium acetate salts present in IsoFin B, which was higher than that present in IsoFin A. In summary, the three IsoFin products that were prepared similar in total carbonyls and active carbonyls, however, they were entirely different in functional performance based on pH, titratable acidity, and acetate salts.

TABLE 7
Characterization of IsoFin A, IsoFin B, IsoFin M, and MA45GF.

| | IsoFin A | IsoFin B | IsoFin M | |
|---|---|---|---|---|
| | Lot# | Lot# | Lot# | MA45GF |
| | 20237UGA | 20217UGA | 20254UGA | Lot# |
| Compound | 1 | 1 | 2 | 0214042486 |
| Glycolaldehyde, mg/100 ml | 4493 | 4219 | 3295 | 45126 |
| | (4.4%) | (4.2%) | (3.3%) | (45.1%) |
| Glyoxal, mg/100 ml | 540 | 438 | 289 | 3579 |
| Total Carbonyls (TC), mg/100 ml | 6095 | 5365 | 4372.0 | 54730 |
| | (6.1%) | (5.4%) | (4.4%) | (54.7%) |
| pH | 4.73 | 5.77 | 5.54 | 2.51 |
| Titratable Acidity (Acetic Acid), % | 10.71 | 1.85 | 3.59 | 1.07 |
| Total Acetate*, % | 21.44 | 19.23 | — | |
| Acetate (as salt)**, % | 10.73 | 17.38 | — | |
| Ratio Acetate Salts Over Acetic | 1.00 | 9.39 | — | |
| Acid | | | | |
| Specific Gravity, g/cc | 1.13 | 1.19 | 1.21 | 1.20 |

*Total Acetate is measured using Megazyme (ACS Manual Format) and it includes acetic acid and acetate salts.
**Acetate (as salt) = Total Acetate-Titratable Acidity

The IsoFin product treated meat products show enhanced texture that resembles that of whole muscle meat due to sufficient crosslink formation. The IsoFin product creates a barrier for moisture due to its cross linking of proteins. It enhances the flavor of the meat products because the active carbonyls compounds and buffered vinegar compounds react with proteins and cause Maillard reactions creating savory notes, like Umami flavor. The Maillard reaction also enhances visual appeal.

The IsoFin product may be used at a level close to the prescribed usage level for optimizing texture of processed plant-based protein and fruit-based meat analogs.

The IsoFin product works because it increases the shelf-life of ready-to-eat meat products from 28 days to over 8 months. It completely stops slime-formation in vacuum-packaged cook meat for up to 8 months. It works because the inclusion of IsoFin products in turkey sausage resulted in inhibition of LAB, along with increasing the shelf life of the product. The IsoFin products penetrate microbial cell wall and inactivate enzymes located in their cytoplasm and its membrane. The IsoFin products connect with amino groups present in the enzyme as active sites, where food substrate binds and get consumed by microbes for its growth. Basically, IsoFin products restrict uptake of nutrients by microbes. Additionally, negligible amounts of 5-(hydroxymethyl) furfural (HMF) present in the selected natural flavoring inhibits hydrolytic enzymes, which are responsible for the uptake of sugars by microbes. While it extends shelf life, the IsoFin products do not impart significant vinegar odor to the treated product.

The IsoFin products benefit from synergistic effect of the active carbonyl compounds and diacetate present in natural smoke flavoring and buffered vinegars, respectively, thereby, providing a multifunctional effect.

1. A composition for enhancing texture, flavor, visual appearance, moisture retention, and/or shelf life of ready to eat food products, consisting of buffered vinegar(s) or other natural organic acid(s) and natural smoke flavor that is rich in carbonyl compounds with the ability to react with and cross-link protein molecules.

2. The composition of claim 1 consisting of:
a. buffered vinegar, which is an industrial strength vinegar buffered with powdered weak bases such as sodium bicarbonate, sodium carbonate, potassium carbonate and potassium bicarbonate, to a range of pH of either 5.85 to 6.15 or 4.55 to 4.85, and
b. the active carbonyl compounds derived from natural smoke flavoring produced by condensing pyrolyzates of hardwood, natural 5- or 6-carbon sugars, or other plant material.

3. The composition of claim 1, where the natural smoke flavor containing the active carbonyl compounds can be 9 to 60% of the total weight of the mixture, and where the exact percentage in the specified range depends on the concentration of the active carbonyl compounds in the natural smoke flavor.

4. The composition of claim 1, wherein the active carbonyl compounds are in selected natural smoke flavors that are commercially available and/or produced from pyrolyzates of various woods species and/or 6-carbon or 5-carbon sugars (sucrose, dextrose, xylose, fructose)—feedstocks of natural origin; and or natural extracts from plants.

5. The composition of claim 1, wherein a prescribed usage of the composition in a food product is about 0.5% to about 2.5% of the food product weight.

6. The composition of claim 5, wherein the usage level may be adjusted to above or below the prescribed level to optimize texture of ready to eat cooked meat products from ground meat to mimic made from whole muscle meat.

7. The composition of claim 2, where the pH may be adjusted between the prescribed ranges to achieve the desired organoleptic attributes of the treated product and provide effective antimicrobial activity.

8. The composition of claim 3, where the proportion of natural smoke flavor to natural organic acids and/or buffered vinegars may be varied to optimize organoleptic (textural or other) attributes and product shelf life.

9. A composition comprising:
buffered vinegar and/or a source of natural organic acid other than vinegar; and
a natural smoke flavoring containing more than 35% by weight of active carbonyl compounds, the active carbonyl compounds being capable of reacting with and cross-linking protein molecules in the ready to eat food product.

10. The composition of claim 9, wherein the buffered vinegar is an industrial strength vinegar buffered with powdered weak bases to a range of pH of 5.85 to 6.15, and
the natural smoke flavoring is produced by condensing pyrolyzates of hardwood, natural 5- or 6-carbon sugars, or other plant material.

11. The composition of claim 10, wherein the powdered weak bases are selected from the group consisting of sodium bicarbonate, sodium carbonate, potassium carbonate, and potassium bicarbonate.

12. The composition of claim 9, wherein the buffered vinegar is an industrial strength vinegar buffered with powdered weak bases to a range of pH of 4.55 to 4.85, and
the natural smoke flavoring is produced by condensing pyrolyzates of hardwood, natural 5- or 6-carbon sugars, or other plant material.

13. The composition in claim 9, wherein the natural smoke flavoring is from 9 to 60% by weight of a total weight of the composition.

14. The composition of claim 9, wherein the active carbonyl compounds are one or more selected from the group consisting of pyrolyzates of a wood species, pyrolyzates of 6-carbon or 5-carbon sugars, and natural extracts from plants.

15. The composition of claim 14, wherein the active carbonyl compounds include pyrolyzates of the 6-carbon or 5-carbon sugars, and the 6-carbon or 5-carbon sugars are one or more selected from the group consisting of sucrose, dextrose, xylose, and fructose.

16. The composition of claim 9, wherein the natural smoke flavoring contains more than 50% by weight of the active carbonyl compounds.

17. The composition of claim 9, wherein the composition contains 4.5 to 5.5% by weight of the active carbonyl compounds.

18. A composition consisting of:
buffered vinegar and/or a source of natural organic acid other than vinegar; and
a natural smoke flavoring containing more than 35% by weight of active carbonyl compounds, the active carbonyl compounds capable of reacting with and cross-linking protein molecules in the ready to eat food product

19. A ready to eat food product, comprising:
a food product, and
about 0.5% by weight to about 5% by weight of the composition according to claim 9 based on a total weight of the food product.

20. The ready to eat food product of claim 16, comprising about 0.5% by weight to about 2.5% by weight of the composition, and 4.5% to 5.5% of the composition is the active carbonyl compounds.
